(19) United States
(12) Patent Application Publication
(10) Pub. No.: US 2023/0206423 A1
(43) Pub. Date: Jun. 29, 2023

(54) METHOD, APPARATUS, ELECTRONIC DEVICE, AND STORAGE MEDIUM FOR DETERMINING DEFECT SHAPE OF WAFER

(71) Applicant: Saimeite Technology Co., Ltd., Jiangsu (CN)

(72) Inventors: Gangjiang Li, Jiangsu (CN); Youhui ZHANG, Jiangsu (CN); Song JIN, Jiangsu (CN)

(21) Appl. No.: 17/952,141

(22) Filed: Sep. 23, 2022

(30) Foreign Application Priority Data
Dec. 29, 2021 (CN) 202111640273.9

(51) Int. Cl. G06T 7/00; G01N 21/95; G06T 7/50; G06V 10/764; G06T 7/70; G06V 20/70

(52) U.S. Cl. CPC G06T 7/001; G01N 21/9501; G06T 7/50; G06T 7/70; G06V 10/764; G06V 20/70; G01N 2021/8887

(57) ABSTRACT

Provided are method, apparatus, electronic device and storage medium for determining defect shape of wafer, wherein the method includes: for a target wafer image of each specification, comparing the target wafer image with the standard wafer image of this specification, and acquiring a coordinate position where each of defect points is located in the target wafer image; according to each coordinate position, projecting each of the defect points into the image to be classified of the target specification on the basis of the preset scaling ratio; determining target points where distance between any two adjacent points in the image to be classified is less than the preset distance; and determining the shape of the region formed by the target points, so as to determine the shape as the defect shape of the target wafer.

### CROSS-REFERENCE TO RELATED APPLICATION

This application claims priority to Chinese Patent Application No. 202111640273.9, filed on Dec. 29, 2021, entitled “METHOD, APPARATUS, ELECTRONIC DEVICE, AND STORAGE MEDIUM FOR DETERMINING DEFECT SHAPE OF WAFER,” the disclosure of which is hereby incorporated herein in its entirety.

### TECHNICAL FIELD

The present disclosure relates to the technical field of wafer manufacturing, and in particular, to a method, an apparatus, an electronic device and a storage medium for determining a defect shape of wafer.

### BACKGROUND ART

Wafer refers to the silicon wafer used to make silicon semiconductor circuits, and raw material thereof is silicon. High-purity polysilicon is dissolved and mixed with silicon crystal seeds, which are then slowly pulled out to form cylindrical monocrystalline silicon. The silicon ingot is ground, polished and sliced to form a silicon wafer, that is, a wafer. The main processing methods of wafers are wafer processing and batch processing, that is, one or more wafers are processed at the same time.

During wafer manufacturing, the higher the production yield of wafer processing device is, the fewer defects in the wafer during processing are, and the smaller the material loss is, and the most critical technology to improve the production yield is how to determine the defect shape of the processed wafer, so that the cause of the wafer defect can be determined according to the defect shape. The inventor found in the research that the defect shape of the processed wafer cannot be automatically identified in the prior art, and manual sampling detection is required.

### SUMMARY

In view of this, embodiments of the present disclosure provide a method, apparatus, electronic device and storage medium for determining defect shape of a wafer, so as to automatically determine the defect shape of each wafer and improve the efficiency of determining the defect shape of the wafer.

In a first aspect, an embodiment of the present application provides a method for determining the defect shape of the wafer, the method comprises:
comparing, for a target wafer image of each specification, the target wafer image with a standard wafer image of this specification, and acquiring a coordinate position where each of defect points is located in the target wafer image, wherein the standard wafer image is an image that does not contain the defect points;
projecting, according to each coordinate position, each of the defect points into an image to be classified of a target specification on the basis of a preset scaling ratio, wherein the defect points in the image to be classified are in one-to-one correspondence to projection points;
determining target points where a distance between any two adjacent points in the image to be classified is less than a preset distance; and
determining a shape of a region formed by the target points, so as to determine the shape as a defect shape of the target wafer.

In one implementable embodiment, after determining the shape as the defect shape of the target wafer, the method further comprises:
marking at least one graphic label used to represent a graphic shape of the defect shape for the target image where the defect shape is located;
acquiring at least one preset defect result that is the same as the graphic shape represented by the at least one graphic label;
comparing the target image with the at least one preset defect result to obtain a target defect result with the highest similarity with the target image; and
determining the target defect result as a classification result of the image to be classified.

In one implementable embodiment, after determining the target defect result as the classification result of the image to be classified, the method further comprises:
determining, for each image to be classified, at least one cause resulting in the target defect result according to the target defect result determined for the image to be classified;
determining the number of occurrences of each cause within a preset time period; and
performing, according to the number of occurrences of each cause, a sorting for at least one cause to obtain a problem list containing the sorting and at least one cause within the preset time period.

In one implementable embodiment, after obtaining the problem list within the preset time period, the method further comprises:

sending data containing the problem list to a display terminal, so as to display the problem list through the display terminal.

In one implementable embodiment, the step of comparing the target wafer image with the standard wafer image of this specification, and acquiring the coordinate position where each of defect points is located in the target wafer image comprises:
acquiring respectively a first gray value image and a second gray value image of the target wafer image and the standard wafer image;
determining, for each same position, target points where a difference value between a gray value in the first gray value image and a gray value in the second gray value image is greater than a preset difference value; and
determining the target points as the defect points.

In a second aspect, an embodiment of the present application further provides an apparatus for determining defect shape of the wafer, the apparatus comprises:
a first comparison unit, configured to compare, for a target wafer image of each specification, the target wafer image with a standard wafer image of this specification, and acquire a coordinate position where each of defect points is located in the target wafer image, wherein the standard wafer image is an image that does not contain the defect points;
a projection unit, configured to project, according to each coordinate position, each of the defect points into an image to be classified of a target specification on the basis of a preset scaling ratio, wherein the defect points in the image to be classified are in one-to-one correspondence to projection points;
a calculation unit, configured to determine target points where a distance between any two adjacent points in the image to be classified is less than a preset distance; and
a first determination unit, configured to determine a shape of a region formed by the target points, so as to determine the shape as a defect shape of the target wafer.

In one implementable embodiment, the apparatus further comprises:
a marking unit, configured to mark at least one graphic label used to represent a graphic shape of the defect shape for the target image where the defect shape is located, after determining the shape as the defect shape of the target wafer;
an acquisition unit, configured to acquire at least one preset defect result that is the same as the graphic shape represented by the at least one graphic label;
a first comparison unit, configured to compare the target image with the at least one preset defect result to obtain a target defect result with the highest similarity with the target image; and
a second determination unit, configured to determine the target defect result as a classification result of the image to be classified.

In one implementable embodiment, the apparatus further comprises:
a third determination unit, configured to determine, for each image to be classified, at least one cause resulting in the target defect result according to the target defect result determined for the image to be classified, after determining the target defect result as the classification result of the image to be classified;
a fourth determination unit, configured to determine the number of occurrences of each cause within a preset time period; and
a sorting unit, configured to perform, according to the number of occurrences of each cause, a sorting for at least one cause to obtain a problem list containing the sorting and at least one cause within the preset time period.

In one implementable embodiment, the apparatus further comprises:

a sending unit, configured to send data containing the problem list to a display terminal, so as to display the problem list through the display terminal, after obtaining the problem list within the preset time period.

In one implementable embodiment, the first comparison unit is configured to
acquire respectively a first gray value image and a second gray value image of the target wafer image and the standard wafer image;
determine, for each same position, target points where a difference value between a gray value in the first gray value image and a gray value in the second gray value image is greater than a preset difference value; and
determine the target points as the defect points.

In a third aspect, an embodiment of the present disclosure further provides an electronic device, which comprises a processor, a storage medium, and a bus, wherein the storage medium stores machine-readable instructions that can be executed by the processor, and when the electronic device runs, the processor and the storage medium communicate through the bus, the processor executes the machine-readable instructions to execute the steps of the method according to any one of the first aspects.

In a fourth aspect, an embodiment of the present disclosure further provides a computer-readable storage medium, a computer program is stored on the computer-readable storage medium, and the computer program is executed by a processor to execute the steps of the method according to any one of the first aspects.

The embodiments of the present disclosure provide a method, apparatus, electronic device and storage medium for determining defect shape of a wafer, wherein the method includes comparing, for a target wafer image of each specification, the target wafer image with the standard wafer image of this specification, and acquiring a coordinate position where each of defect points is located in the target wafer image; according to each coordinate position, projecting each of the defect points into the image to be classified of the target specification on the basis of the preset scaling ratio; determining target points where distance between any two adjacent points in the image to be classified is less than the preset distance; and determining the shape of the region formed by the target points, so as to determine the shape as the defect shape of the target wafer. Compared with the manual sampling detection solution in the prior art, the method provided by the embodiment of the present disclosure can automatically identify the defect shape of the wafer.

In order to make the above-mentioned objects, features and advantages of the present disclosure more obvious and easier to understand, the preferred embodiments are exemplified below, and are described in detail as follows in conjunction with the accompanying drawings.

### BRIEF DESCRIPTION OF DRAWINGS

In order to more clearly illustrate the technical solutions of the embodiments of the present disclosure, accompanying drawings which need to be used in the embodiments will be introduced briefly below, it should be understood that the following accompanying drawings only show some embodiments of the present disclosure, therefore it should not be seen as a limitation of scope. And those ordinarily skilled in the art still could obtain other related drawings in light of these accompanying drawings, without using any inventive efforts.

FIG. 1 shows a flowchart of a method for determining a defect shape of a wafer provided by an embodiment of the present disclosure.

FIG. 2 shows a flowchart of a method for determining a classification result provided by the embodiment of the present disclosure.

FIG. 3 shows a structural schematic view of an apparatus for determining the defect shape of the wafer provided by the embodiment of the present disclosure.

FIG. 4 shows a structural schematic view of an electronic device provided by the embodiment of the present disclosure.

### DETAILED DESCRIPTION OF EMBODIMENTS

In order to make the purposes, technical solutions and advantages of the embodiments of the present disclosure clearer, the technical solutions in the embodiments of the present disclosure will be described clearly and completely below with reference to the accompanying drawings in the embodiments of the present disclosure. It should be understood that the accompanying drawings in the present disclosure are only for illustration and description purposes, and are not used to limit the protection scope of the present disclosure. In addition, it should be understood that the schematic drawings are not drawn to scale of real objects. The flowcharts used in the present disclosure illustrate operations implemented in accordance with some embodiments of the present disclosure. It should be understood that the operations of the flowcharts may be implemented out of order and that steps without logical context relationship may be implemented in reverse order or concurrently. In addition, those skilled in the art can add one or more other operations to the flowchart, and can also remove one or more operations from the flowchart under the guidance of the content of the present disclosure.

In addition, the described embodiments are only some of the embodiments of the present disclosure, but not all of the embodiments. The components of the embodiments of the present disclosure generally described and illustrated in the drawings herein may be arranged and designed in a variety of different configurations. Therefore, the following detailed description of the embodiments of the present disclosure provided in the accompanying drawings is not intended to limit the scope of the present disclosure as claimed, but is merely representative of selected embodiments of the present disclosure. Based on the embodiments of the present disclosure, all other embodiments obtained by those skilled in the art without making creative work fall within the protection scope of the present disclosure.

It should be noted in advance that the term “comprising” will be used in the embodiments of the present disclosure to indicate the existence of features declared later, but does not exclude the addition of other features.

It should be noted in advance that, the apparatuses or electronic devices, etc. involved in the embodiments of the present disclosure may be executed on a single server, or may be executed on a server group. Server groups can be centralized or distributed. In some embodiments, the server may be local or remote relative to the terminal. For example, a server may access information and/or data stored in a service requester terminal, a service provider terminal, or a database, or any combination thereof, via a network. As another example, the server may connect directly to at least one of a service requester terminal, a service provider terminal, and a database to access stored information and/or data. In some embodiments, the server may be implemented on a cloud platform; by way of example only, the cloud platform may include private cloud, public cloud, hybrid cloud, community cloud, distributed cloud, inter-cloud, multi-cloud, etc., or any combination of them.

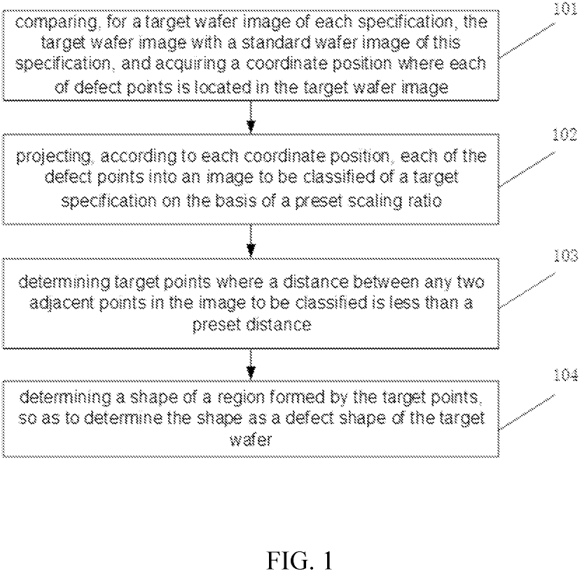

FIG. 1 shows a flowchart of a method for determining a defect shape of a wafer provided by an embodiment of the present disclosure. As shown in FIG. 1, the method includes the following steps.

Step 101: comparing, for a target wafer image of each specification, the target wafer image with a standard wafer image of this specification, and acquiring a coordinate position where each of defect points is located in the target wafer image, wherein the standard wafer image is an image that does not contain the defect points.

Specifically, in the process of chip manufacturing, after the wafer processing is completed, the wafer is usually analyzed to determine whether the wafer is damaged during the processing, and whether the processing result of the wafer meets the expected requirements. The size of the wafer depends on the production requirements, and the size of each wafer is not necessarily the same, so the size of the obtained wafer image is not fixed. The specifications of the wafer are determined according to the size of the captured wafer image. The target wafer image is an image of the wafer to be identified. The standard wafer image is an image of a preset standard wafer without any processing defects, for the target wafer image of each specification, the standard wafer image with the same specification as the target wafer image is provided.

By comparing the target wafer image with the defect-free standard wafer image, the coordinate positions of points differed from this standard wafer image in the target wafer image can be identified, and each of points is identified as a defect point in this target wafer image.

Step 102: projecting, according to each coordinate position, each of the defect points into an image to be classified of a target specification on the basis of a preset scaling ratio, wherein the defect points in the image to be classified correspond one-to-one to projection points.

Specifically, the preset scaling ratio is determined according to the ratio of the target wafer image to the specification of the image to be classified, and the target specification is preset; the projection point is the point corresponding to each defect point in the image to be classified; the position of each projection point in the image to be classified is the same as the position of the defect point corresponding to the projection point in the target wafer image. Each of defect points in the target wafer image is projected to the image to be classified of the target specification according to the preset scaling ratio. In the embodiment of the present disclosure, the image to be classified is composed of a background color and projection points different from the background color, so as to highlight the projection point corresponding to each of defect points.

Step 103: determining target points where a distance between any two adjacent points in the image to be classified is less than a preset distance.

Specifically, after obtaining the image to be classified containing the projection point corresponding to each defect point according to step 103, in the image to be classified, the first distance between every two adjacent projection points is calculated. A second distance whose value is less than or equal to that of the preset distance is screened out from each of the calculated first distances; and the projection point corresponding to each second distance is taken as the target point. The preset distance can be adjusted according to the actual situation, and the embodiment of the present disclosure does not limit the arrangement method of the preset distance.

Step 104: determining a shape of a region formed by the target points, so as to determine the shape as a defect shape of the target wafer.

Specifically, each of target points determined in step 103 is covered by the region formed by the target points. After the region is determined, the contour of the region is drawn according to an algorithm, so that the shape of the region formed by the target points is determined according to the shape of the contour. The embodiment of the present disclosure does not limit the method of delineating the contour of region, which may determine each target point in the outermost layer of the region according to the algorithm, and connect each target point in the outermost layer of the region in sequence, or may also extract the edge contour of the region according to an edge extraction algorithm after the region is determined, so as to obtain the shape of the region. After the shape of the region is determined, the shape is determined as the defect shape of the target wafer corresponding to the target wafer image.

The embodiments of the present disclosure provide a method for determining defect shape of a wafer, by comparing, for a target wafer image of each specification, the target wafer image with the standard wafer image of this specification, and acquiring a coordinate position where each of defect points is located in the target wafer image; according to each coordinate position, projecting each of the defect points into the image to be classified of the target specification on the basis of the preset scaling ratio; determining target points where distance between any two adjacent points in the image to be classified is less than the preset distance; and determining the shape of the region formed by the target points, the shape is determined as the defect shape of the target wafer. Compared with the manual sampling detection solution in the prior art, the method provided by the embodiment of the present disclosure can automatically determine the defect shape of each wafer, thereby improving the efficiency of the determining the defect shape of the wafer.

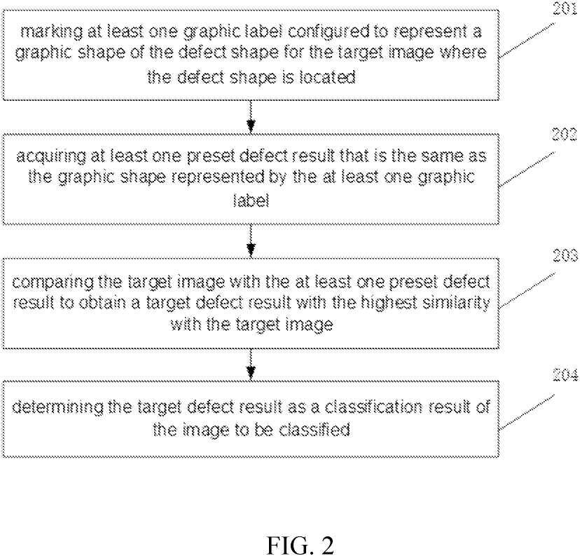

In an implementable embodiment, FIG. 2 shows a flowchart of a method for determining a classification result provided by an embodiment of the present disclosure. As shown in FIG. 2, after step 104 is executed to determine the shape of the region formed by the target points to determine the shape as the defect shape of the target wafer, the method further includes the following steps.

Step 201: marking at least one graphic label used to represent a graphic shape of the defect shape for the target image where the defect shape is located.

Specifically, the graphic shape of the defect shape is determined by means of graphic analysis, graphic recognition, etc., and at least one graphic label is marked for the target image where the defect shape is located. The graphic label includes: a circular shape, a linear shape, an irregular shape, and an undefined shape, and the target image is an image that only contains target points.

Step 202: acquiring at least one preset defect result that is the same as the graphic shape represented by the at least one graphic label.

The preset defect result is a pre-stored image containing standard defect shapes, and each preset defect result is marked with a graphic label used to represent the graphic shape of the preset defect result. After at least one graphic label is marked for the defect shape according to step 201, according to the graphic label marked for each preset defect result, the preset defect result having the same graphic label as that of the defect shape is determined.

In the embodiment of the present disclosure, ten types of defect results are listed, respectively: a first defect result in which the defect points are concentrated in the center region of the target wafer; a second defect result in which the defect points are concentrated outside the center of the target wafer and are in an annular shape; a third defect result in which the defect points are concentrated in a certain irregular region of the edge of the target wafer; a fourth defect result in which the defect points are concentrated on the edge contour of the target wafer; a fifth defect result in which the defect points are concentrated in a certain irregular area inside the target wafer; a sixth defect result in which defect points are uniformly distributed in each region of the wafer; a seventh defect result in which the defect points concentratedly occupy most of the region of the target wafer; a eighth defect result in which the defect points form a linear shape inside the target wafer; a ninth defect result in which the defect points have no obvious features; and a tenth defect result in which there are no obvious defect points.

In the above, the first defect result, the second defect result, the fourth defect result, and the sixth defect result are respectively marked with a graphic label of “circular shape”; the third defect result, the fifth defect result, and the seventh defect result are respectively marked with a graphic label of “irregular shape”; the eighth defect result is marked with a graphic label of “linear shape”; the ninth defect result and tenth defect result are marked with a graphic label of “undefined shape”.

In Example 1, after the shape of the region formed by the target points in the image to be classified is identified as a linear shape via step 201, the image to be classified is marked with a graphic label of “linear shape”. Then, among the ten types of defect results, a defect result in which graphic label is “linear shape” is acquired, thereby obtaining the eighth defect result.

Step 203: comparing the target image with the at least one preset defect result to obtain a target defect result with the highest similarity with the target image.

Specifically, a pre-trained similarity model can be used to analyze the similarity between the target image containing the defect shape and the preset defect result, thereby obtaining the target defect result with the highest similarity with the target image containing the defect shape according to the similarity model.

The similarity model is trained and obtained in the following method.

The neural network model is iteratively trained through a data set containing a preset number of training atlases to adjust the learning rate of the neural network model according to the first difference value between the training result and the real result; the real result is pre-marked for the training atlases, and the training result is the results of marking the training atlases by the neural network model; the data set includes a training set and a test set; and the training atlas is the target image containing the defect shape;
when the second difference value between the training result obtained by the neural network model based on the adjusted learning rate and the real result is less than or equal to a preset threshold, the adjusted learning rate is used as the preset learning rate of the neural network model;
the accuracy rate of the neural network model under the adjusted learning rate is tested through the test set; and
if the accuracy rate is in the first preset interval, the neural network model based on the adjusted learning rate is used as the similarity model.

Step 204: determining the target defect result as a classification result of the image to be classified.

In the embodiment of the present disclosure, after obtaining the target defect result with the highest similarity, a secondary checkout may be further performed to determine whether a similarity value between the target defect result and the target image containing the defect shape exceeds a preset minimum similarity threshold, if the similarity value between the target defect result and the image to be classified does not exceed the preset minimum similarity threshold, the target defect result is the secondary-selected defect result of the image to be classified. The specific checkout method is:
if the similarity value between the target defect result and the target image containing the defect shape is less than the preset minimum similarity, taking the target defect result as the secondary-selected defect result of the defect shape;
acquiring other defect results in the preset defect results except the secondary-selected defect result;
calculating a second similarity between each of the other defect results and the target image containing the defect shape; and
taking the preset defect result corresponding to the second similarity with the highest numerical value in the second similarities as the second target defect result, wherein
if the second similarity corresponding to the second target defect result is greater than or equal to the preset minimum similarity, the second target defect result is determined as the classification result of the image to be classified; and
if the second similarity corresponding to the second target defect result is less than the preset minimum similarity, the defect result with a higher similarity value in the second target defect result and the secondary-selected defect result is determined as the classification result of the image to be classified.

In Example 2, based on the content provided in Example 1, another implementable embodiment is provided. After obtaining the eighth defect result and the image to be classified in which graphic labels are all “linear shape”, the above similarity model is used to perform similarity analysis on the target image containing the defect shape and the standard image of the eighth defect result, thereby obtaining the similarity value between the target image containing the defect shape and the eighth defect result, since the preset defect result in which graphic labels are all “linear shape” has only the eighth defect result, it is determined that the eighth defect result is the target defect result of the image to be classified. The eighth defect result is checked, if the similarity value between the eighth defect result and the target image containing the defect shape is lower than the preset minimum similarity, it indicates that the judgment error may be caused by the wrong labeling of the graphic label, then the eighth defect result is used as the secondary-selected defect result. The similarity calculation is in sequence performed between the target image containing the defect shape and other defect results except the eighth defect result among the ten defect results. The similarity ranking between the target image containing the defect shape and each preset defect result among the ten defect results is obtained, and the preset defect result with the highest similarity is used as the second target defect result.

In one implementable embodiment, after performing step 204 to determine the target defect result as the classification result of the image to be classified, the method further includes the following steps of.

Step 210: determining, for each image to be classified, at least one cause resulting in the target defect result according to the target defect result determined for the image to be classified.

Specifically, according to the ten types of defect results introduced in step 202, at least one cause resulting in the defect result is preset for each defect result, and after determining the target defect result of the image to be classified according to step 204, the defect cause corresponding to the image to be classified is determined according to at least one cause preset for the target defect result.

In Example 3, if the defect shape in the image to be classified is a “linear shape”, and the obtained preset defect result matching the defect shape in similarity is “the eighth defect result”, then the eighth defect result is regarded as the target defect result corresponding to the image to be classified, the preset cause of the “eighth defect result” is assumed as “scratch”, the defect cause corresponding to the image to be classified is “scratch”. If the “eighth defect result” also corresponds to other reasons, such as “abrasion” and “collision”, the defect causes of the image to be classified are “scratch”, “abrasion”, and “collision”. In the embodiment of the present disclosure, it is also possible to determine the specific device, components, and device parameter that specifically cause the defect cause for each defect cause, so as to directly locate the faulty component.

Step 211: determining the number of occurrences of each cause within a preset time period.

Specifically, the preset time period can be set, adjusted and modified according to the actual situation and actual needs. At least one defect shape of target wafer should be determined within the arrangement range of the preset time period. The longer the preset time period is, the more results are obtained for the defect shape of the target wafer, the more accurate the statistics will be. However, in order to ensure the accuracy in the production and processing, the preset time period should be set within a reasonable range, so as to adjust the parameters of the processing device, processing mode and the like in time, according to the defect shape of the target wafer, thereby reducing the cause of defects.

Step 212: performing, according to the number of occurrences of each cause, a sorting for at least one cause to obtain a problem list containing the sorting and at least one cause within the preset time period.

Specifically, after determining the number of occurrences of each cause within the preset time period according to step 212, the sorting is performed for each cause to obtain a problem list containing each cause, the serial number of each cause, and the number of occurrences of each cause.

In one implementable embodiment, after obtaining the problem list within the preset time period according to step 212, the method further includes the following steps:

sending data containing the problem list to a display terminal, so as to display the problem list through the display terminal.

Specifically, the data containing the problem list is sent to the display terminal, so that the user can obtain the cause resulting in the wafer defect in real time from the display terminal, modify the device parameters and adjust the processing method according to the problem list, thereby improving the yield of wafer production.

In one implementable embodiment, when performing step 101, the method includes the following steps.

Step 220: acquiring respectively a first gray value image and a second gray value image of the target wafer image and the standard wafer image.

Specifically, the target wafer image and the standard wafer image are subjected to grayscale processing to obtain the first gray value image of the target wafer image and the second gray value image of the standard wafer image.

Step 221: determining, for each same position, target points where a difference value between a gray value in the first gray value image and a gray value in the second gray value image is greater than a preset difference value.

Specifically, the specifications of the target wafer image and the standard wafer image are the same, and for each same position in the first gray value image and the second gray value image, the difference value between the gray values of this position in the two images is calculated, for each difference value, if the difference value is greater than the preset difference value, it is considered that the pixel point at this position is the target point; or a point formed by a target number of pixel points can be used as a visible point. If the number of pixel points in which difference value in the visible points in the first gray value image and the second gray value image is greater than the preset difference value exceeds a certain proportion, the visible point is determined as the target point.

Step 222: determining the target point as the defect point.

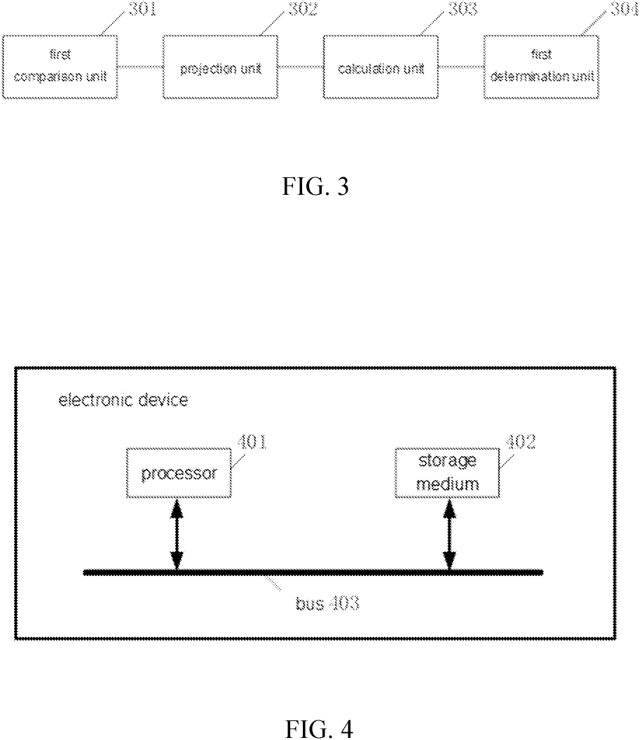

FIG. 3 shows a schematic structural view of an apparatus for determining defect shape of the wafer provided by an embodiment of the present disclosure. As shown in FIG. 3, the apparatus includes: a first comparison unit 301, a projection unit 302, and a calculation unit 303, and a first determination unit 304.

The first comparison unit 301 is configured to compare, for a target wafer image of each specification, the target wafer image with a standard wafer image of this specification, and acquire a coordinate position where each of defect points is located in the target wafer image, wherein the standard wafer image is an image that does not contain the defect points.

The projection unit 302 is configured to project, according to each coordinate position, each of the defect points into an image to be classified of a target specification on the basis of a preset scaling ratio, wherein the defect points in the image to be classified correspond one-to-one to projection points.

The calculation unit 303 is configured to determine target points where a distance between any two adjacent points in the image to be classified is less than a preset distance.

The first determination unit 304 is configured to determine a shape of a region formed by the target points, so as to determine the shape as a defect shape of the target wafer.

In one implementable embodiment, the apparatus further comprises:
a marking unit, configured to mark at least one graphic label used to represent a graphic shape of the defect shape for the target image where the defect shape is located, after determining the shape as the defect shape of the target wafer;
an acquisition unit, configured to acquire at least one preset defect result that is the same as the graphic shape represented by the at least one graphic label;
a first comparison unit, configured to compare the target image with the at least one preset defect result to obtain a target defect result with the highest similarity with the target image; and
a second determination unit, configured to determine the target defect result as a classification result of the image to be classified.

In one implementable embodiment, the apparatus further comprises:
a third determination unit, configured to determine, for each image to be classified, at least one cause resulting in the target defect result according to the target defect result determined for the image to be classified, after determining the target defect result as the classification result of the image to be classified;
a fourth determination unit, configured to determine the number of occurrences of each cause within a preset time period;
a sorting unit, configured to perform, according to the number of occurrences of each cause, a sorting for at least one cause to obtain a problem list containing the sorting and at least one cause within the preset time period.

In one implementable embodiment, the apparatus further comprises:

a sending unit, configured to send data containing the problem list to a display terminal, so as to display the problem list through the display terminal, after obtaining the problem list within the preset time period.

In one implementable embodiment, the first comparison unit is configured to
acquire respectively a first gray value image and a second gray value image of the target wafer image and the standard wafer image;
determine, for each same position, target points where a difference value between a gray value in the first gray value image and a gray value in the second gray value image is greater than a preset difference value; and
determine the target points as the defect points.

The embodiments of the present disclosure provide an apparatus for determining defect shape of a wafer, by comparing, for a target wafer image of each specification, the target wafer image with the standard wafer image of this specification, and acquiring a coordinate position where each of defect points is located in the target wafer image; according to each coordinate position, projecting each of the defect points into the image to be classified of the target specification on the basis of the preset scaling ratio; determining target points where distance between any two adjacent points in the image to be classified is less than the preset distance; and determining the shape of the region formed by the target points, the shape is determined as the defect shape of the target wafer. Compared with the manual sampling detection solution in the prior art, the apparatus provided by the embodiment of the present disclosure can automatically identify the defect shape of the wafer.

FIG. 4 shows a schematic structural view of an electronic device provided by an embodiment of the present disclosure, which comprises a processor 401, a storage medium 402, and a bus 403, wherein the storage medium 402 stores machine-readable instructions that can be executed by the processor 401. When the electronic device operates the method for determining the defect shape of the wafer in the embodiments, the processor 401 communicates with the storage medium 402 through a bus 403, and the processor 401 executes the machine-readable instructions to execute the steps in the embodiments.

In an embodiment, the storage medium 402 can also execute other machine-readable instructions to execute other methods described in the embodiment. For the specifically executed method steps and principles, the description of the embodiment can be referred, which will not be repeated in detail herein.

Embodiments of the present disclosure further provide a computer-readable storage medium, a computer program is stored on the computer-readable storage medium, and the computer program is executed when run by the processor, so as to execute the steps in the embodiments.

In the embodiments of the present disclosure, when the computer program is run by the processor, other machine-readable instructions may also be executed to perform other methods described in the embodiments. For the specifically executed method steps and principles, the description of the embodiment can be referred, which will not be repeated in detail herein.

In the several embodiments provided by the present disclosure, it should be understood that the disclosed system, apparatus and method may be achieved by other manners. The apparatus embodiments described above are only illustrative. For example, the division of the modules is only a logical function division. In actual implementation, there may be other division methods. As another example, multiple modules or components may be combined or may be integrated into another system, or some features may be omitted, or not implemented. On the other hand, the shown or discussed mutual coupling or direct coupling or communication connection may be indirect coupling or communication connection through some communication interfaces, apparatuses or modules, which may be in electrical, mechanical or other forms.

The modules described as separate components may or may not be physically separated, and the components shown as modules may or may not be physical units, that is, may be located in one place, or may also be distributed to multiple network units. Some or all of the units may be selected according to actual needs to achieve the purpose of the solution in this embodiment.

In addition, each functional unit in each embodiment of the present disclosure may be integrated into one processing unit, or each unit may also exist physically alone, or two or more units may be integrated into one unit.

The functions, if implemented in the form of software functional units and sold or used as stand-alone products, may be stored in a processor-executable non-volatile computer-readable storage medium. Based on this understanding, the technical solution of the present disclosure in essence, or the part that contributes to the prior art or the part of the technical solution can be embodied in the form of a software product. The computer software product is stored in a storage medium, and includes several instructions to cause a computer device (which may be a personal computer, a server, or a network device, etc.) to execute all or part of the steps of the methods described in the various embodiments of the present disclosure. The aforementioned storage medium includes: a U disk, a removable hard disk, a ROM, a RAM, a magnetic disk, or an optical disk, and other various media that can store program codes.

The above are only specific embodiments of the present disclosure, but the protection scope of the present disclosure is not limited to this. Any person skilled in the art can easily think of changes or substitutions within the technical scope disclosed in the present disclosure, which should be covered within the protection scope of the present disclosure. Therefore, the protection scope of the present disclosure shall be subject to the protection scope of the claims.

What is claimed is:

1. A method for determining a defect shape of a wafer, wherein the method comprises steps of:
comparing, for a target wafer image of each specification, the target wafer image with a standard wafer image of this specification, and acquiring a coordinate position where each of defect points is located in the target wafer image, wherein the standard wafer image is an image that does not contain the defect points;
projecting, according to each coordinate position, each of the defect points into an image to be classified of a target specification according to a preset scaling ratio, wherein defect points in the image to be classified correspond one-to-one to projection points;
determining target points where a distance between any two adjacent points in the image to be classified is less than a preset distance; and
determining a shape of a region formed by the target points, so as to determine the shape as a defect shape of a target wafer.

2. The method according to claim 1, wherein after determining the shape as a defect shape of a target wafer, the method further comprises:
marking at least one graphic label used to represent a graphic shape of the defect shape for a target image where the defect shape is located;
acquiring at least one preset defect result that is the same as a graphic shape represented by the at least one graphic label;
comparing the target image with the at least one preset defect result to obtain a target defect result with the highest similarity with the target image; and
determining the target defect result as a classification result of the image to be classified.

3. The method according to claim 2, wherein after determining the target defect result as a classification result of the image to be classified, the method further comprises:
determining, for each image to be classified, at least one cause resulting in the target defect result according to the target defect result determined for the image to be classified;
determining the number of occurrences of each cause within a preset time period;
performing, according to the number of occurrences of each cause, a sorting for the at least one cause to obtain a problem list containing the sorting and the at least one cause within the preset time period.

4. The method according to claim 3, wherein after obtaining the problem list within the preset time period, the method further comprises:
sending data containing the problem list to a display terminal, so as to display the problem list through the display terminal.

5. The method according to claim 1, wherein the step of comparing the target wafer image with a standard wafer image of this specification, and acquiring a coordinate position where each of defect points is located in the target wafer image comprises:
acquiring respectively a first gray value image and a second gray value image of the target wafer image and the standard wafer image;
determining, for each same position, target points where a difference value between a gray value in the first gray value image and a gray value in the second gray value image is greater than a preset difference value; and
determining the target points as the defect points.

6. An apparatus for determining a defect shape of a wafer, wherein the apparatus comprises:
a first comparison unit, configured to compare, for a target wafer image of each specification, the target wafer image with a standard wafer image of this specification, and acquire a coordinate position where each of defect points is located in the target wafer image, wherein the standard wafer image is an image that does not contain the defect points;
a projection unit, configured to project, according to each coordinate position, each of the defect points into an image to be classified of a target specification according to a preset scaling ratio, wherein defect points in the image to be classified correspond one-to-one to projection points;
a calculation unit, configured to determine target points where a distance between any two adjacent points in the image to be classified is less than a preset distance; and
a first determination unit, configured to determine a shape of a region formed by the target points, so as to determine the shape as a defect shape of a target wafer.

7. The apparatus according to claim 6, wherein the apparatus further comprises:
a marking unit, configured to mark at least one graphic label used to represent a graphic shape of the defect shape for a target image where the defect shape is located, after determining the shape as the defect shape of the target wafer;
an acquisition unit, configured to acquire at least one preset defect result that is the same as a graphic shape represented by the at least one graphic label;
a first comparison unit, configured to compare the target image with the at least one preset defect result to obtain a target defect result with the highest similarity with the target image; and
a second determination unit, configured to determine the target defect result as a classification result of the image to be classified.

8. The apparatus according to claim 6, wherein the first comparison unit is configured to:
acquire respectively a first gray value image and a second gray value image of the target wafer image and the standard wafer image;
determine, for each same position, target points where a difference value between a gray value in the first gray value image and a gray value in the second gray value image is greater than a preset difference value; and
determine the target points as the defect points.

9. An electronic device, comprising: a processor, a storage medium, and a bus, wherein the storage medium stores machine-readable instructions capable of being executed by the processor, and when the electronic device runs, the processor and the storage medium communicate through the bus, the processor executes the machine-readable instructions to execute steps of the method for determining a defect shape of a wafer according to claim 1.
